(19) United States
(12) Patent Application Publication
(10) Pub. No.: US 2022/0374786 A1
(43) Pub. Date: Nov. 24, 2022

(54) SYSTEMS AND METHODS FOR CORPORATE EVENT DISTRIBUTION AND AUTHENTICATION

(71) Applicant: Zoom Video Communications, Inc., San Jose, CA (US)

(72) Inventors: Aleksandra Swerdlow, Santa Clara, CA (US); Ya Lee, Saratoga, CA (US); Pankaj Prasad, San Francisco, CA (US); Wei Li, Cupertino, CA (US); Yoshifumi Takebuchi, San Jose, CA (US)

(21) Appl. No.: 17/324,021

(22) Filed: May 18, 2021

(51) Int. Cl. G06Q 10/02; G06F 21/31; G06F 16/2455; G06N 20/00

(52) U.S. Cl. CPC G06Q 10/02; G06F 21/31; G06F 16/2455; G06N 20/00

(57) ABSTRACT

One example system for corporate event distribution and authentication includes a processor and at least one memory device. The memory device includes instructions that are executable by the processor to cause the processor to distribute an invitation to a plurality of users, the invitation associated with a plurality of related events, receive a request for access information associated with the invitation, the request originating from a user of the plurality of users, authenticate a credential of the user, generate a ticket to one or more of the plurality of related events in response to successful authentication of the user, the ticket including a secure access information uniquely associated with the one or more of the plurality of related events and with the user, and transmit the ticket to the user associated with the request.

### FIELD

The present application generally relates to video events and more particularly relates to systems and methods for corporate event distribution and authentication.

### BACKGROUND

Providers of in-person events sometimes desire a mechanism for providing services when in-person events are impractical. For example, event organizers may wish to create, host, and monetize events like fitness classes, concerts, stand-up or improv shows, and music lessons virtually using an online event provider. Such events may include one-time events, an event series, or drop-ins. The online event provider may allow the creator to list and sell tickets as well as share and promote public events via messaging and social media application. Such online event provider platforms allow creators to reach new audiences beyond a particular geographical location as well as cope with unforeseen disruption of in-person event hosting.

### SUMMARY

Various examples are described for systems and methods for recommending events to users. One example system includes a processor and at least one memory device. The memory device includes instructions that are executable by the processor to cause the processor to distribute an invitation to a plurality of users, the invitation associated with a plurality of related events, receive a request for access information associated with the invitation, the request originating from a user of the plurality of users, authenticate a credential of the user, generate a ticket to one or more of the plurality of related events in response to successful authentication of the user, the ticket including a secure access information uniquely associated with the one or more of the plurality of related events and with the user, and transmit the ticket to the user associated with the request.

One example method includes distributing an invitation to a plurality of users, the invitation associated with a plurality of related events, receiving a request for access information associated with the invitation, the request originating from a user of the plurality of users, authenticating a credential of the user, generating a ticket to one or more of the plurality of related events in response to successful authentication of the user, the ticket including a secure access information uniquely associated with the one or more of the plurality of related events and with the user, and transmitting the ticket to each of the one or more of the plurality of related events to the user associated with the request.

One example non-transitory computer-readable medium includes code that is executable by a processor for causing the processor to distribute an invitation to a plurality of users, the invitation associated with a plurality of related events, receive a request for access information associated with the invitation, the request originating from a user of the plurality of users, authenticate a credential of the user, generate a ticket to one or more of the plurality of related events in response to successful authentication of the user, the ticket including a secure access information uniquely associated with the one or more of the plurality of related events and with the user, and transmit the ticket to the user associated with the request.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1 and 2 illustrate example systems to enable corporate event distribution and authentication;

FIG. 3 illustrates an example method for providing corporate event distribution and authentication;

FIG. 4 illustrates an example method for correlating users and events using a machine learning model; and

FIG. 5 shows an example computing device suitable for use with any disclosed systems or methods according to this disclosure.

### DETAILED DESCRIPTION

Examples are described herein in the context of systems and methods for corporate event distribution and authentication. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video event systems provide a platform on which users can search for, obtain admission to, and enjoy interactive and engaging virtual experiences from creators of all sizes, from large media organizations to creative individuals. Hosts can easily create, list, and monetize their events on the platform.

In one example system, a host may create a collection of related events. For example, the host may create a single day, single-track, multi-session webinar. The webinar includes a plurality of events, each event associated with a particular session. For example, each session might be associated with a particular time slot. The host then distribute invitations to the webinar, the track, or individual sessions to a plurality of users. For instance, a host may create a webinar for use in a particular organization, and the organization may have a domain, e.g., company.com. The host may choose to create private events, public events, or a combination of private and public events. The host then distributes an invitation to particular users or groups of users. For instance, in one example, the host is able to distribute invitations to the entire domain of an organization by specifying the domain, rather than individually inviting specific users within the organization.

In the example system, when a user receives the invitation, the user can choose to request a ticket to the event by, for example, clicking on a link embedded in the invitation. The user's request is sent to the event provider, which then generates a ticket to the event for the user. The user receives the ticket and can then use the ticket to later access the event. For example, the user may access an event hub or dashboard that lists all the sessions or the webinar. Each webinar may include a “lobby” from which the user can access the individual sessions. For each session displayed in the lobby for which the user has a ticket, the example system displays a “join” button when the session is active. The user is able to click the join button and access the session. In some examples, the user may be able to create a schedule of sessions within the webinar. Then when a particular session is active in the user's schedule, the user is automatically directed to the active session.

To ensure security, the example system may utilize authentication. For example, when the user requests the ticket, the example system may use authenticate the user based on the user's credentials. The user's credentials may include, for example, the user's email address and password. In other examples, the user may utilize a single-sign on service. The user's credentials or other information may then be used together with information about the event to create a ticket that is unique to a user and the event. In other words, no two tickets are the same. When the user attempts to use the ticket to later access the event, the attributes of the ticket can be authenticated to ensure that the ticket is genuine and the user authentication is successful.

Such video event systems provide numerous advantages. For example, example systems may provide a simpler method of distributing invitations to events, such as corporate events. By generating a unique ticket and performing user authentication, such systems may also provide a more secure mechanism for accessing an event than would be provided by distributing event information to attendees, such as an event identifier or link and event password. Such video event systems may also provide a more convenient mechanism for organizing events to which the user has obtained a ticket. For example, such systems may improve the creation and execution of single- and multi-day, multi-track, and multi-session online meetings or webinars.

This illustrative example is given to introduce the reader to the general subject matter discussed herein and the disclosure is not limited to this example. The following sections describe various additional non-limiting examples and examples of systems and methods for corporate event distribution and authentication.

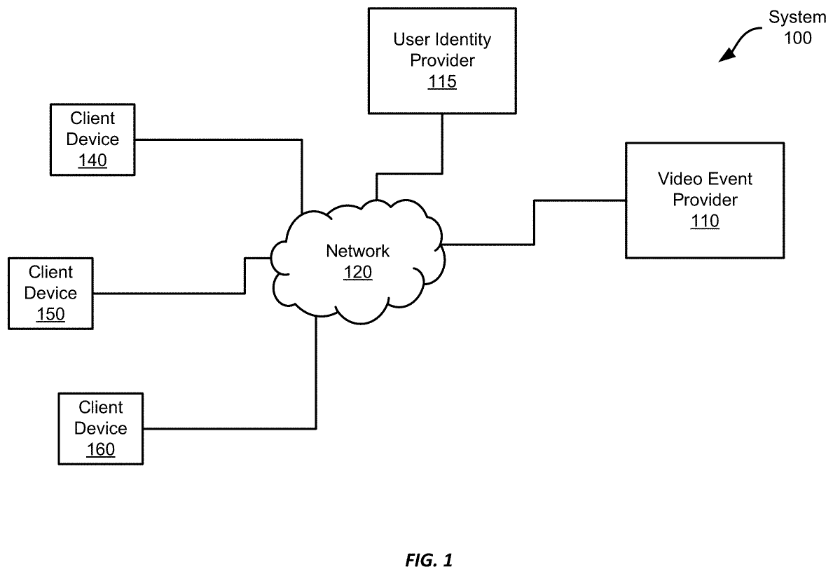

Referring now to FIG. 1, FIG. 1 shows an example system 100 that provides video conferencing functionality to various client devices. The system 100 includes a video event provider 110 that is connected to multiple communication networks 120, 130, through which various client devices 140-160 can participate in video events hosted by the video event provider 110. For example, the video event provider 110 can be located within a private network to provide video conferencing services to devices within the private network, or it can be connected to a public network, e.g., the internet, so it may be accessed by anyone. Some examples may even provide a hybrid model in which a video event provider 110 may supply components to enable a private organization to host private internal video events or to connect its system to the video event provider 110 over a public network.

The system optionally also includes one or more user identity providers, e.g., user identity provider 115, which can provide user identity services to users of the client devices 140-160 and may authenticate user identities of one or more users to the video event provider 110. In this example, the user identity provider 115 is operated by a different entity than the video event provider 110, though in some examples, they may be the same entity.

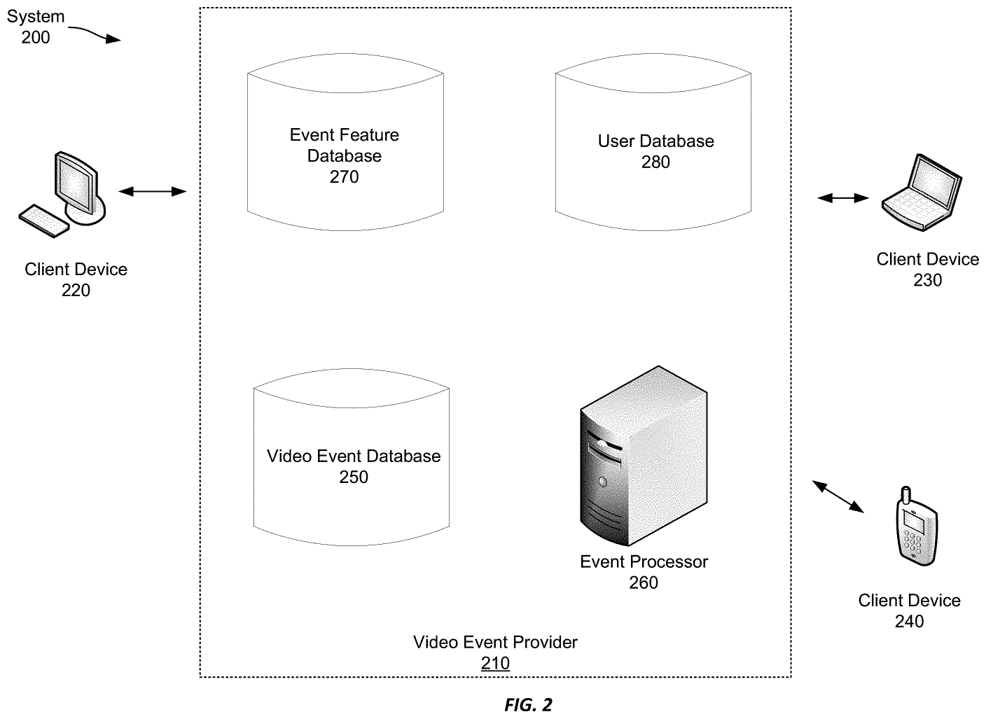

Video event provider 110 allows clients to create video events (or “events”), such as webinars, online classes, concerts and shows. The user can then group the events into single- or multi-day, single- or multi-track, multi-session collections of events. The user or host is then able to invite other users to participate in those events as well as perform other related functionality, such as recording the events, generating transcripts from event audio, manage user functionality in the events, enable text messaging during the events, etc. FIG. 2, described below, provides a more detailed description of the architecture and functionality of the video event provider 110.

To create an event with the video event provider 110, an even host may contact the video event provider 110 using a client device 140-160 and select an option to create a new event. Such an option may be provided in a webpage accessed by a client device 140-160 or client application executed by a client device 140-160. In other examples, the user may create a file, such as a comma separated values (CSV) file containing information about the events that are to be created. To create the event, the video event provider 110 may prompt the host for certain information, such as a date, time, and duration for each event, a number of participants, whether the event is confidential or open to the public, etc. The host may also specific the event security, for example, allowing attendees to change screen names or share their screens. In some examples, the host may also select various recording options. After receiving the various event settings, the video event provider may create a record for each of the event and for the collection of events and generate an event identifier for each event and collection of events. These identifiers are then provided to the event host.

After receiving the event information, the host may select various types of tickets that will be distributed to one or more users who will participate or attend the events. For example, if an event includes a panel, the user may create one or more panelist tickets. In addition, the host may create alternative host tickets. The host will also create attendee tickets. In some example systems, the attendee tickets may require payment or be free. The attendee may receive an invitation to purchase tickets to all of the related events as one transaction, e.g., all the sessions in a single-day, single-track webinar or all of the sessions in a particular track of a single-day, multi-track webinar.

The host may also restrict tickets to certain users. For instance, the host may create a guest list or a white list, specifying all of the users who are invited and thus able to obtain tickets. Alternatively, the host may specify a domain or domains (e.g., company.com) to which invitations will be sent. When the host completes these specifications, the host can save the event to the video event provider 110. Once saved, the host can publish the collection of events, at which point the various users can obtain tickets. The host may choose to publish the event publicly or privately. For example, the host may allow anyone in an organization to view a webinar and its associated sessions. Alternatively, the host may publish the webinar privately, limiting those who can see the webinar and its associated sessions to a subset of users.

Users can view a list of events and then select a group of events or in some cases a particular event for which to obtain a ticket. In some cases, the user receives an invitation, and can use the invitation by, for example, clicking on a link, to obtain a ticket. When the user clicks the link or otherwise selects an event, the video event provider 110 may authenticate the user to ensure the user has the appropriate credentials to access the event or group of events. The video event provider 110 then generates the ticket. The user uses the ticket to access an event from the user's client devices 140-160. The user may be directed to an interface, such as a page in an application, on which all of the events for a webinar or meeting are displayed. The page may be referred to as a “lobby” or “hub.” The user may be able to see all the events in the lobby or particular events to which the user has access.

Depending on the options set for the event, the users may be admitted immediately upon providing the appropriate ticket and authentication information, even if the host has not yet arrived, or the users may be presented with information indicating the that event has not yet started or the host may be required to specifically admit one or more of the users.

During a particular event, the participants may be able to employ their client devices 140-160 to capture audio or video information and stream that information to the video event provider 110. They also receive audio or video information from the video event provider 210, which is displayed by the respective client device 140 to enable the various users to participate in the event.

At the end of the event, the host may select an option to terminate the event, or it may terminate automatically at a scheduled end time or after a predetermined duration. When the event terminates, the various participants are disconnected from the event and they will no longer receive audio or video streams for the event (and will stop transmitting audio or video streams). The user may then be redirected to the hub or lobby for the collection of events the user is attending.

To provide such functionality, one or more client devices 140-160 may communicate with the video event provider 110 using one or more communication networks, such as network 120. The client devices 140-160 may be any suitable computing or communications device that have audio or video capability. For example, client devices 140-160 may be conventional computing devices, such as desktop or laptop computers having processors and computer-readable media, connected to the video event provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in an event hosted by the video event provider 110.

Referring again to client devices 140-160, these devices 140-160 contact the video event provider 110 using network 120 and may provide information to the video event provider 110 to access functionality provided by the video event provider 110, such as access to create new events or join existing events. To do so, the client devices 140-160 may provide user identification information, event identifiers, tickets, etc. In examples that employ a user identity provider 115, a client device, e.g., client devices 140-160, may operate in conjunction with a user identity provider 115 to provide user identification information or other user information to the video event provider 110.

A user identity provider 115 may be any entity trusted by the video event provider 110 that can help identify a user to the video event provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video event provider 110.

When the user accesses the video event provider 110 using a client device, the video event provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video event provider 110 either provides or denies access to its services, respectively.

It should be appreciated that for certain events, users may choose to participate in events anonymously and decline to provide user identification information to the video event provider 110, even in cases where the user has an authenticated identity and employs a client device capable of identifying the user to the video event provider 110. The video event provider 110 may determine whether to allow such anonymous users to use services provided by the video event provider 110. Anonymous users, regardless of the reason for anonymity, may be restricted, and in some cases may be prevented from accessing certain events or other services, or may be entirely prevented from accessing the video event provider 110.

Referring again to video event provider 110, in some examples, it may allow client devices 140-160 to encrypt their respective video and audio streams to help improve privacy in their events. Encryption may be provided between the client devices 140-160 and the video event provider 110 or it may be provided in an end-to-end configuration where multimedia streams transmitted by the client devices 140-160 are not decrypted until they are received by another client device 140-160 participating in the event. Encryption may also be provided during only a portion of a communication, for example encryption may be used for otherwise unencrypted communications that cross international borders.

Client-to-server encryption may be used to secure the communications between the client devices 140-160 and the video event provider 110, while allowing the video event provider 110 to access the decrypted multimedia streams to perform certain processing, such as recording the event for the participants or generating transcripts of the event for the participants. End-to-end encryption may be used to keep the event entirely private to the participants without any worry about a video event provider 110 having access to the substance of the event. Any suitable encryption methodology may be employed, including key-pair encryption of the streams. For example, to provide end-to-end encryption, the event host's client device may obtain public keys for each of the other client devices participating in the event and securely exchange a set of keys to encrypt and decrypt multimedia content transmitted during the event. Thus the client devices 140-160 may securely communicate with each other during the event. Further, in some examples, certain types of encryption may be limited by the types of devices participating in the event. Thus, while encrypting the multimedia streams may be desirable in many instances, it is not required as it may prevent some users from participating in an event.

By using the example system shown in FIG. 1, users can create and participate in events using their respective client devices 140-160 via the video event provider 110. Further, such a system enables users to use a wide variety of different client devices 140-160 from traditional standards-based video conferencing hardware to dedicated video conferencing equipment to laptop or desktop computers to handheld, etc.

Referring now to FIG. 2, FIG. 2 shows an example system 200 in which a video event provider 210 provides corporate event distribution and authentication. Users access events from the video event provider utilizing various client devices 220-240. The video event provider 210 may provide a web page displaying a collection of links to events that are available for a user to attend virtually. For example, the video event provider 210 may display a lobby for a particular collection of events. The video events may be displayed based on interactions of a user with an event, e.g., purchasing access to the event, various features of the event, or historical interactions of the user with various events as described herein. In other embodiments, the video event provider may provide a dashboard or wallet, which displays various collections of events, such as webinars or meetings, that the user may be interested in or events for which the user has already obtained a ticket. The dashboard may also be capable of displaying various analytics regarding the user and events. In some examples, the dashboard thus becomes a mechanism by which the user can access all the events the user has registered for, will serve on a panel for, or is hosting.

The client devices 220-240 include two conventional computing devices 220-230 and a smartphone device 240. Each client device 220-240 communicates with the video event provider 210 over a communications network, such as the internet for client devices 220-240, generally as described above with respect to FIG. 1. The video event provider 210 is also in communication with one or more user identity providers 215, which can authenticate various users to the video event provider 210 generally as described above with respect to FIG. 1.

In this example, the video event provider 210 employs multiple different servers (or groups of servers) to provide different aspects of video event functionality, thereby enabling the various client devices to create and participate in video events. Each of these servers is connected to one or more communications networks to enable them to collectively provide access to and participation in one or more video event meetings to the client devices 220-240.

The video event provider includes an event processor 260. The event processor 260 is able to provide a list of events for each user based on tickets purchased by the user, invitations sent to the user, or predictions of events in which the user may have an interest. Such predictions may be based, for example, on a user's historical interaction with events. The event processor 260 accesses one or more databases storing information regarding events and user's purchases or other interactions with events.

The example system 200 shown includes a video event database 250. The video event database 250 includes events created by event hosts. For example, a host may create an event corresponding to a class to be held during a webinar. In other examples, the host may pre-record a video of a class. The video event database may include the video as well as features related to the event, including both text and non-text features. Text features may include, for example, the event title, description, the category, and a tag, which is a host-defined word or phrase. Non-text features may include, for example, the start and end date and time, the day of the week, flags indicating that the event is on a weekend or a holiday, the days remaining until the event, the host, whether the event is public or private, the price and currency, sales prices and periods, and the category of the event.

The event database 250 also includes relationships between various events. For example, the event database may include data indicating that a set of events are individual sessions in an all-day, single-track webinar. In another example, the sessions may be associated with individual sessions during a multi-day, multi-track meeting or tradeshow, where each session is associated with a particular date and time and a particular track and multiple sessions may occur simultaneously.

The video event provider also includes an event feature database 270. The event feature database 270 stores features extracted from the video event database 250. For example, the event feature database 270 may include a list of event identifiers and associated text and non-text features. The event feature database 270 can then be used by the event processor to determine similarities between the various events based on a comparison of the various features of each event.

The video event provider 210 also includes a user database 280. The user database 280 stores information regarding the user's historical interactions with various events, including purchases and invitations. The events associated with the user in user database 280 are also associated with various event features. These user-associated event features are stored in the event feature database 270. Historical user interactions stored in the user database 280 may include various categories, such as actions and ratings. Actions may include, for example, purchases, invitations, gifts, likes, and clicks. Actions may also include interactions with one or more other users. For instance, an action may reflect that a user attended an event hosted by a particular user. In another example, an action may reflect that two users have attended some of the same events. Ratings may include, for example, a numerical or alphanumeric score associated by a particular user with a particular event, or a number of stars (or other icon) out of a maximum number of stars, etc. The users' actions may be used to display a list of upcoming events for which the user has a ticket or has received an invitation. The user's actions and ratings can be used to create a recommended event list for the user.

It should be appreciated that the components of the video event provider 210 discussed above are merely examples of such devices and an example architecture. Some video event providers may provide more or less functionality than described above and may not separate functionality into different types of servers as discussed above. Instead, any suitable servers and network architectures may be used according to different examples.

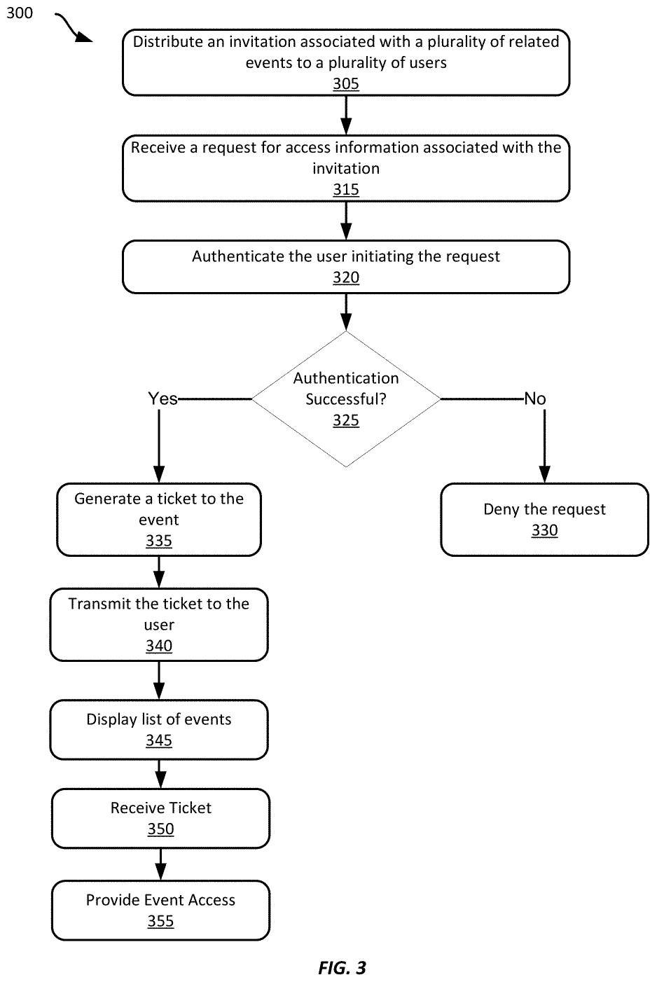

Referring now to the method 300 illustrated in FIG. 3, FIG. 3 shows an example method 300 for corporate event distribution and authentication. The description of the method 300 in FIG. 3 will be made with reference to the system 100 and 200 shown in FIGS. 1 and 2; however any suitable system according to this disclosure may be used, such as the example systems 100 and 200 shown in FIGS. 1 and 2.

At block 305, an event processor 260 at video event provider 210 distributes an invitation to a plurality of users. The invitation is associated with a plurality of events. For instance, as described above, a host may create a multi-day, multi-track meeting that includes a plurality of sessions. Each session is created as an event with a set of attributes, such as start and end time, presenters, and title. The host may then associate the various sessions with one another. For instance, the host may identify a subset of the events as belonging to a particular track in the meeting, e.g., “thought leadership.” The invitation may be created for the entire meeting or may be created for a particular track or some other subset of sessions in the meeting.

The plurality of users to which the invitation is sent may defined in a number of ways. For example, the host may create a guest list or white list of particular users who are able to request tickets to a collection of events. The host may do this manually or may, for instance, create a file and upload the file to the video event provider 210 for processing. In another example, the plurality of users may be associated with a domain, and the event processor 260 may distribute the invitation to the domain or to multiple domains. For example, a company domain, such as company.com, may be associated with all the employees of the company. Each user may have an email address, such as name@company.com. The video event processor 260 creates and sends an email that includes the invitation to each user associated with the domain.

Then at block 310, for each event, the event processor 260 receives a request for access information associated with one of the invitations distributed to the plurality of users. For example, a user may use client device 230 to open an email that includes the invitation. The user then clicks on a link in the email to send a request to the event processor 260 for access information.

In block 320, the event processor 260 authenticates the user that initiated the request. For example, the user may provide a credential, such as a username/password pair to the event processor 260 for authentication. In some examples, as part of the authentication step, the event processor 260 may determine whether the user is part of a guest list or white list created by the host as is described above.

In block 325, the event processor 260 determines whether the authentication was successful. For example, the event processor 260 may access a user database 260 to match the provided credentials with previously-stored credentials. Or the event processor may contact a user identify provider, such as user identity provider 115 shown in FIG. 1.

If the authentication is not successful, then at block 330, the event processor 260 denies the request for access information. In some examples, the event processor 260 may provide the user with one or more additional attempts to request the access information.

In block 335, the event processor 260 generates a ticket to the event. The ticket includes secure access information uniquely associated with the event and with the user. In other words, no two tickets are the same. Only the user associated with the ticket may access the event associated with the ticket. This is in contrast to events in which the same event identifier and passcode combination is made available to all event participants. In the example in which an invitation for an event is distributed to all users in a domain, each user requesting access information to the event associated with the invitation would receive their own unique ticket to each event. In a multi-session event, such as a webinar, the user may thus have multiple tickets. In other embodiments, the user receives a single ticket to a collection of related events. For instance, in a multi-track meeting, the user may receive a ticket to a particular track, such as the “thought leadership” track mentioned above. In that case, the ticket could be used to access each session in the track. In other examples, tickets may be created for various tiers. In one example, a meeting may include a VIP tier and a general admission tier. The VIP ticket may then be tied to various tracks, such as the thought leadership track. The user with the VIP ticket could then attend any of the events in the tracks associated with the VIP tier. The general admission tier may only have access to general sessions, such as a keynote speech, but not have access to sessions in the thought leadership track. The tiers may be related. For example, the VIP tier may include all the sessions associated with the general admission tier. While this example includes only two related tiers, various combinations and interrelationships between the tiers may be created by the host. For instance, the various tiers may be independent of one another. A host may associate each of the various tiers with various levels of pricing. For instance, a host may determine that the VIP ticket should be more expensive than a general admission ticket. In some examples, the price of each ticket varies based on, for example, the level of interest in various tiers, the proximity of the purchase of a ticket to the event—the closer to the event date, the more expensive the ticket, or based on various other parameters.

Once the event processor 260 generates the ticket, then at block 340 the event processor 260 transmits the ticket to the user. Transmission of the ticket may take the form of an email with a link. In other examples, transmission of the tickets is accomplished by storing ticket information in the user database 280 and notifying the user that the user has successfully obtained the ticket. In other examples, the ticket is sent to the user and stored on the user's client device 220-240.

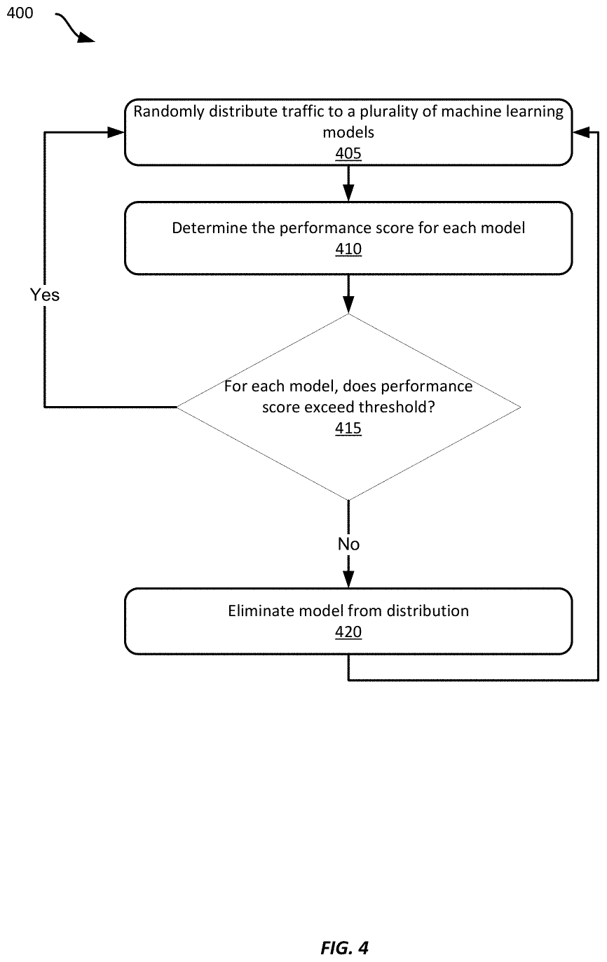

At block 345, the event processor 260 or the user's client device 220-240 causes a list of events to be displayed. For example, the user may access a link to a webinar and be presented with a webinar lobby in which all events associated with the webinar are displayed. For instance, all of the webinar sessions may be displayed in a calendar form based on start date/time or they may be displayed in list form in order of start time. In another example, the client device might access the user database 280 to determine all of the events for which the user has obtained a ticket or an invitation and display those events to the user as a dashboard or wallet. The event processor may then sort the list based on attributes of the event, such as the event date or event popularity. The event processor 260 may also sort the list of events by determining a set of user preferences, such as favored types of events or hosts, correlating the set of user preferences with attributes of the various events, and then sorting the list of events based at least in part on the correlation. For instance, if the user lists a particular host as a favorite, then events associated with the host may be displayed at the top of the list. The correlation may be performed using one or more machine learning models as described in relation to FIG. 4.

Once the list of events is displayed, the user can select an event for which the user has a ticket. The user's request causes the ticket to be transmitted to the event processor 260, which receives the ticket at block 350.

The event processor 260 then authenticates the user, and assuming authentication is successful, provides the user with access to the event. For example, when the user accesses a webinar lobby, as events for which the user has obtained a ticket become active, a “join now” button may be displayed in the virtual lobby. When the user clicks the “join now” button, the user is redirected into the event or the event is displayed in another window within the users application or interface. In another example, the event processor 260 may redirect the user's browser application to the URL for the event along with a code that demonstrates the user has been authenticated. In another example, if only one session is associated with the user for a particular time, the user may be automatically taken to that session when the session begins without requiring further affirmative action by the user.

In the method shown in FIG. 4, a plurality of machine learning models are used to correlate events and users as described in relation to block 345 in FIG. 3. As described below, the process 400 is iterative. At the end of each iteration, a model's performance is compared to a threshold to determine whether to phase a model out. In the example method, the threshold is set based on a performance score, and the value of the threshold is 0.1. Other measures of performance and values of the threshold may be utilized in various examples. In some examples, rather than phasing a model out, the model may be replaced by another model.

In step 405, the user event data, e.g., data related to newly-created events, is randomly distributed to a plurality of machine learning models in order to correlate users and events. For example, in a first iteration, user event data may be distributed randomly but evenly to each model 220-250, i.e., 25% of the event data is processed by each model. Then the events are displayed to users in each user's user interface based on the correlation. For example, the first event displayed to the user may be the event the user is predicted to be most interested in. And the second displayed event would be the event predicted to be the one the user is next most likely to be interested in.

At step 410, the example method tracks various users' interactions with the events displayed in each user's user interface to determine the model's performance score. In the example method shown, each event's click-through rate (or conversion rate) is tracked and then used to evaluate the model's performance. Other measures may be utilized, such as a user suggesting the event to a friend. In one example method, the performance score is normalized to a number between 0 and 1, and the sum of the performance measure across the four models 220-250 equals 1. For example, in an example using four models, the performance score for model 1 might equal 0.15, for model 2 equal 0.2, for model 3 equal 0.5, and for model D equal 0.15.

At step 415, the model's performance score is compared to a threshold. In the example system the threshold is set to 0.1. The threshold may be determined based on experience with past performance of various machine learning models. Further, the performance measure may be varied based on the type of user event data 500. For instance, some types of user event data may result in more variance between machine learning models and thus a higher threshold for phasing out a particular model may be appropriate. If the performance score for the particular model exceeds the threshold, then the model will be utilized in the next iteration of the method 400. If not, then at step 420, the model where the performance score is below the threshold is phased out of the example system 500 prior to the next iteration. In other examples, the lowest performing model is phased out without reference to a threshold.

During the subsequent interaction of the method 400, user event data is again randomly distributed to each model at step 405, however the distribution is based on a ratio that is proportional to the model performance score from the first interaction of the method 400. For instance, in the example method, model 1 receives 15% of the traffic during this second iteration because its performance score from the first iteration was calculated as 0.15. Then the process 400 continues for this second iteration. The process continues to iterate until all but a single model 220-250 remains. At that point, the optimal model for that particular set of user event data 500 has been identified, and process 400 ends. In some embodiments, a model may be retrained or updated as additional data is created in the system.

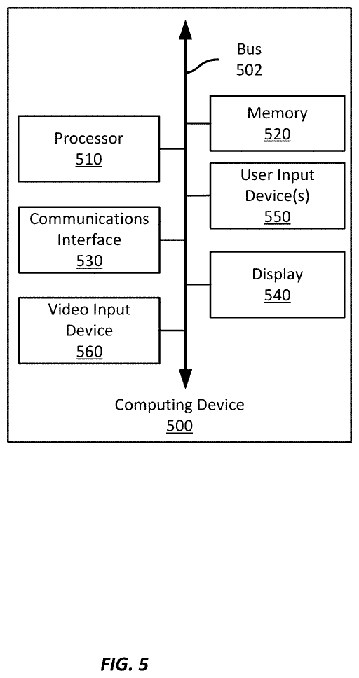

Referring now to FIG. 5, FIG. 5 shows an example computing device 500 suitable for use in example systems or methods for sharing content across video conferencing sub-meetings. The example computing device 500 includes a processor 510 which is in communication with the memory 520 and other components of the computing device 500 using one or more communications buses 502. The processor 510 is configured to execute processor-executable instructions stored in the memory 520 to perform one or more methods for providing waiting notifications and managing a waiting queue according to different examples, such as part or all of the example method 500 described above with respect to FIG. 5. The computing device, in this example, also includes one or more user input devices 550, such as a keyboard, mouse, touchscreen, video input device (e.g., one or more cameras), microphone, etc., to accept user input. The computing device 500 also includes a display 540 to provide visual output to a user as well as a video input device 550, such as a camera, to capture visual input.

The computing device 500 also includes a communications interface 530. In some examples, the communications interface 530 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
distributing an invitation to a plurality of users, the invitation associated with a plurality of related events;
receiving a request for access information associated with the invitation, the request originating from a user of the plurality of users;
authenticating a credential of the user;
generating a ticket to one or more of the plurality of related events in response to successful authentication of the user, the ticket including a secure access information uniquely associated with the one or more of the plurality of related events and with the user; and
transmitting the ticket to each of the one or more of the plurality of related events to the user associated with the request.

2. The method of claim 1, further comprising:
receiving the ticket including the secure access information from the user; and
providing the user with access to the one or more of the plurality of related events.

3. The method of claim 1, further comprising determining whether the user is a member of a guest list or a domain associated with the one or more of the plurality of related events before generating the ticket.

4. The method of claim 1, further comprising:
determining a list of events associated with a user;
sorting the list of events; and
causing the list of events to be displayed on a user's device.

5. The method of claim 4, where determining the list of events associated with the user comprises searching a database of events based on at least one of an event invitation associated with a user and a user interaction history.

6. The method of claim 5, wherein the user interaction history includes a history of the user's interactions with one or more other users.

7. The method of claim 4, where sorting the list of events associated with the user comprises:
determining a set of user preferences;
correlating the set of user preferences with event attributes; and
sorting the list of events based at least in part on the correlation.

8. The method of claim 5, wherein correlating the set of user preferences with event attributes comprises applying at least one of a plurality of machine learning models.

9. The method of claim 8, further comprising selecting an optimal machine learning model of the plurality of machine learning models based on the evaluation of the performance of each of the plurality of machine learning models.

10. A system comprising:
a processor; and
at least one memory device including instructions that are executable by the processor to cause the processor to:
distribute an invitation to a plurality of users, the invitation associated with a plurality of related events;
receive a request for access information associated with the invitation, the request originating from a user of the plurality of users;
authenticate a credential of the user;
generate a ticket to one or more of the plurality of related events in response to successful authentication of the user, the ticket including a secure access information uniquely associated with the one or more of the plurality of related events and with the user; and
transmit the ticket to the user associated with the request.

11. The system of claim 10, further comprising instructions that are executable by the processor to cause the processor to:
receive ticket including the secure access information; and
provide the user with access to the one or more of the plurality of related events.

12. The system of claim 10, further comprising instructions that are executable by the processor to cause the processor to determine whether the user is a member of a guest list or a domain associated with the one or more of the plurality of related events before generating the ticket.

13. The system of claim 10, further comprising instructions that are executable by the processor to cause the processor to:
determine a list of events associated with a user;
sort the list of events; and
cause the list of events to be displayed on a user's device.

14. The system of claim 13, where the instructions that are executable by the processor to cause the processor to determine the list of events associated with the user comprise instructions that are executable by the processor to cause the processor to search a database of events based on at least one of an event invitation associated with a user and a user interaction history.

15. The system of claim 14, wherein the user interaction history includes a history of the user's interactions with one or more other users.

16. The system of claim 13, where instructions that are executable by the processor to cause the processor to sort the list of events associated with the user comprise instructions that are executable by the processor to cause the processor to:
determine a set of user preferences;
correlate the set of user preferences with event attributes; and
sort the list of events based at least in part on the correlation.

17. The system of claim 16, wherein instructions that are executable by the processor to cause the processor to correlate the set of user preferences with event attributes comprise instructions that are executable by the processor to cause the processor to applying at least one of a plurality of machine learning models.

18. The system of claim 15, further comprising instructions that are executable by the processor to cause the processor to select an optimal machine learning model of the plurality of machine learning models based on the evaluation of the performance of each of the plurality of machine learning models.

19. A non-transitory computer-readable medium comprising code that is executable by a processor for causing the processor to:
distribute an invitation to a plurality of users, the invitation associated with a plurality of related events;
receive a request for access information associated with the invitation, the request originating from a user of the plurality of users;
authenticate a credential of the user;
generate a ticket to one or more of the plurality of related events in response to successful authentication of the user, the ticket including a secure access information uniquely associated with the one or more of the plurality of related events and with the user; and
transmit the ticket to the user associated with the request.

20. The non-transitory computer-readable medium of claim 19, further comprising instructions that are executable by the processor to cause the processor to.
receive the ticket including the secure access; and
provide the user with access to the event.
